(19) United States
(12) Patent Application Publication
(10) Pub. No.: US 2007/0214405 A1
(43) Pub. Date: Sep. 13, 2007

(54) Method of multimedia file playback for optical storage medium

(76) Inventors: Li-Ying Chang, Changhua City (TW); Chia-Wei Pan, Hsinchu City (TW)

Correspondence Address: J.C. Patents, Inc., Suite 205, 4 Venture, Irvine, CA, 92618, US

(21) Appl. No.: 11/453,442

(22) Filed: Jun. 14, 2006

(30) Foreign Application Priority Data
Mar. 13, 2006 (TW) 95108358

(51) Int. Cl. G06F 15/00

(52) U.S. Cl. 715/500.1

(57) ABSTRACT

A method of multimedia file playback for an optical storage medium adapted for playing a multimedia file stored in the optical storage medium is disclosed. The multimedia file includes a playback information and a media data. The method includes the steps as follows: first, sorting the playback information to obtain a sorted playback information table; compressing the sorted playback information table into a plurality of compressed partitions; establishing a time index table used for recording the starting playback time of each compressed partition; and finally, decompressing the compressed partitions sequentially to read the media data according to the time index table, so as to play the multimedia file.

### CROSS-REFERENCE TO RELATED APPLICATION

This application claims the priority benefit of Taiwan application serial no. 95108358, filed on Mar. 13, 2006. All disclosure of the Taiwan application is incorporated herein by reference.

### BACKGROUND OF THE INVENTION

1. Field of Invention

The present invention relates to a method for playing multimedia data, and more particularly, to a method of multimedia file playback for an optical storage medium.

2. Description of Related Art

With the development of science and technology, the audio-video multimedia playing device, such as a CD-ROM or DVD-ROM has become an indispensable household appliance in modern life. The playback application using ISO/IEC 14496 file format has also become the mainstream application for the current playing device.

FIG. 1 shows a block diagram of a conventional multimedia file format using the ISO/IEC 14496 file format. A multimedia file using ISO/IEC14496 file format includes special data storage regions 100 and 101, a playback information storage region 102, and a multimedia data storage region 103, wherein a plurality of chunks is stored in the multimedia data storage region; each chunk includes a part of the video data, audio data, sub-picture/sub-title, and other data (e.g., image data), which are referred as multimedia samples. Five tables directed to various multimedia samples are stored in the playback information storage region 102, namely, a synopsis table of time-multimedia sample (STTS), a synopsis table of multimedia sample-synchronism (STSS), a synopsis table of multimedia sample-chunk (STSC), a synopsis table of multimedia sample size information (STSZ), and a synopsis table of chunk offset (STCO).

The STTS is used to store the corresponding relationship between playback time points and multimedia samples. The STSS is used to store the corresponding relationship between the multimedia samples and synchronous frames. The STSC is used to store the number of multimedia samples contained in each chunk. The STSZ is used to store the size information of each multimedia sample. The STCO is used to store the address of each chunk in the multimedia file.

When multimedia files with ISO/IEC 14496 file format are played, first, according to a playback time, the STTS is queried to find out the multimedia sample corresponding to the playback time. Next, the multimedia sample corresponding to the time may be a predicted frame (P-frame) or a bidirectional frame (B-frame), such that the STSS is queried to find out the intra coded frame (I-frame) most close to the playback time. Then, the STSC is queried by using the above I-frame, so as to find out which multimedia sample in which chunk it is. Then, by using the STSZ, the sizes of all multimedia samples in the chunk are found out. Finally, the STCO is queried to obtain the address of the chunk in the multimedia file with ISO/IEC14496 file format. The above steps are repeated to obtain the playback relevant information of each multimedia data, and then the playback relevant information are analyzed to find out the next multimedia sample to be played. After each multimedia sample has been played, it is needed to repeat all the above actions to determine which type of multimedia sample is to be played until the file has been completely played.

Generally, taking portable products, such as a flash memory, as an example, since the flash memory has a rapid speed for random accessing, when a certain segment has been played, the table required for the next segment of the playback information can be loaded quickly. Furthermore, taking a general personal computer as an example, since the memory of the personal computer is sufficiently large enough for storing all the above tables, when a multimedia file with ISO/IEC14496 file format is to be played, the required table is directly looked up in the memory. However, in the above two applications, it still requires to continuously determine the playback sequence for various types of multimedia samples. When an optical storage medium (e.g., sounder/VCD/DVD player) plays this type of file, as for each type of multimedia sample, a part of the above five tables must be read from the multimedia file in, for example, CD/DVD, and after the file has been analyzed and played according to the read table, the next part of the five tables is further read from the multimedia file in the CD/DVD for continuous analyzing and playing.

In the above playback method, the optical pickup head must read back and forth. When the segment of the optical disk for storing the read data and above tables exceeds a certain distance in length, the problem of unsmooth playback occurs. Thus, this playback method is not suitable for the optical storage medium. In order to avoid this circumstance, the memories must be increased for storing the above five tables of various multimedia samples, which requires a relatively large memory space, thus, it is infeasible for devices with limited memory, such as a sounder/VCD/DVD player.

### SUMMARY OF THE INVENTION

An object of the present invention is to provide a method of multimedia file playback for an optical storage medium, used for playing a multimedia file stored in the optical storage medium with limited memory.

Another object of the present invention is to provide a method of multimedia file playback for an optical storage medium, used for playing a multimedia file stored in the optical storage medium in a manner of cost-saving.

Yet another object of the present invention is to provide a method of multimedia file playback for an optical storage medium, so as to avoid the unsmooth playback caused by frequently switching optical pickup head for reading.

The present invention provides a method of multimedia file playback for an optical storage medium, used for playing a multimedia file stored in the optical storage medium. The multimedia file includes a playback information and a media data. The method includes the following steps. First, a play-forward information table is established according to the playback information of various multimedia samples. The play-forward information table, used for recording the sequence and data length of various types of media chunk, includes N chunk information records. Next, the indexes of the chunk information records are sequentially defined, wherein N is a natural number, and each chunk information record includes a chunk type field and a chunk size field. The chunk type field is used to store media types of adjacent identical media data required when playing the multimedia file. The media types at least include a video type or an audio type, and a discard type. The chunk size field is used to store the length of the media data indicated by the chunk type field.

Next, if the random playback function is supported, a random playback information table is established according to the playback information, which includes a plurality of random playback information records, and each random playback information record includes a key frame information field and a relevant audio information field. The key frame information field represents the relevant information of the synchronous frame in the media data of the multimedia file. The relevant audio information field represents the information of the relevant audio corresponding to the synchronous frame. The key frame information field includes a play-forward information table index field, a time index field, a current address field, and a chunk remainder size field. The play-forward information table index field is used to store the indexes of the chunk information records corresponding to the chunk data where the synchronous frame is located. The time index field is used to store the time elapsed from the beginning to the time for playing the synchronous frame during playing the media data of the multimedia file. The current address field is used to store the current address of the synchronous frame in the media data. The chunk remainder size field is used to store the distance from the synchronous frame as a beginning to the end point of the chunk data where the synchronous frame is located. The audio data field includes a play-forward information table index field, a time index field, a current address field, and an audio sample number field. The play-forward information table index field is used to store the indexes of the chunk information records corresponding to the chunk data where the audio data is located. The time index field is used to store the time difference between the audio data and the start point of the corresponding chunk data. The current address field is used to store the current data of the synchronous frame in the media data. The audio sample number field is used to store the number of an audio sample. According to the play-forward information table index field of the audio and video data, it is determined to first play audio data or video data, and it is also determined whether there are chunk data need to be discarded in the audio and video data to be played. Finally, the multimedia file is played according to the play-forward information table and the random playback information table. When the audio data has a variable bit transmission rate, the size information of each audio sample is required to be recorded or dynamically accessed, such that the start position and end position of each audio sample can be obtained according to this information; and when to switch to play the next chunk also can be calculated.

The present invention provides a method of multimedia file playback for an optical storage medium, suitable for playing a multimedia file stored in the optical storage medium. The multimedia file includes a playback information and a media data. The method includes the following steps. First, the redundant information in the playback information is removed, such that the playback information is sorted to obtain a sorted playback information table. The sorted playback information table is compressed into a plurality of compressed partitions. A time index table used for recording the starting playback time of each compressed partition is established. Finally, the compressed partitions are sequentially decompressed according to the time index table to read the media data, so as to play the multimedia file.

The present invention provides a method of multimedia file playback for an optical storage medium, suitable for playing a multimedia file stored in the optical storage medium. The multimedia file includes a playback information and a media data. The method includes the following steps. First, the playback information is divided into a plurality of segments. As for the segment to be played, the redundant information in the playback information corresponding to the segment to be played is removed, such that the playback information in this segment is sorted to obtain a sorted playback information table. The media data is read according to the sorted playback information table, so as to play the multimedia file. Finally, after this segment has been played, the next segment is sorted to obtain a sorted playback information table.

The present invention sorts the playback information in the multimedia data to obtain the sorted playback information table, such that 60%-80% of the memory space for storing the playback information table can be saved. With this method, the originally existing playback data is significantly simplified. This method not only avoids the unsmooth playback caused by frequently switching the pickup head, but also enables the device with relative strict memory limitation to play the multimedia file normally. Furthermore, according to the embodiment of the present invention, the dividing and compressing methods are used for the circumstance with limited memory, so as to further reduce the use of memory.

In order to make the aforementioned and other objects, features and advantages of the present invention comprehensible, preferred embodiments accompanied with figures are described in details below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 shows a block diagram of a conventional multimedia file format in an ISO/IEC 14496 file format.

FIG. 2 shows a flow chart of a method of multimedia file playback for an optical storage medium according to an embodiment of the present invention.

FIG. 3 shows a play-forward information table established before playing the multimedia file according to an embodiment of the present invention.

FIG. 4 shows a random playback information table established before playing the multimedia file according to an embodiment of the present invention.

FIG. 5 shows a flow chart of a method of multimedia file playback for an optical storage medium according to an embodiment of the present invention.

FIG. 6 shows a flow chart of a method of multimedia file playback for an optical storage medium according to an embodiment of the present invention.

FIG. 7 shows a flow chart of a method of multimedia file playback for an optical storage medium according to an embodiment of the present invention.

### DESCRIPTION OF EMBODIMENTS

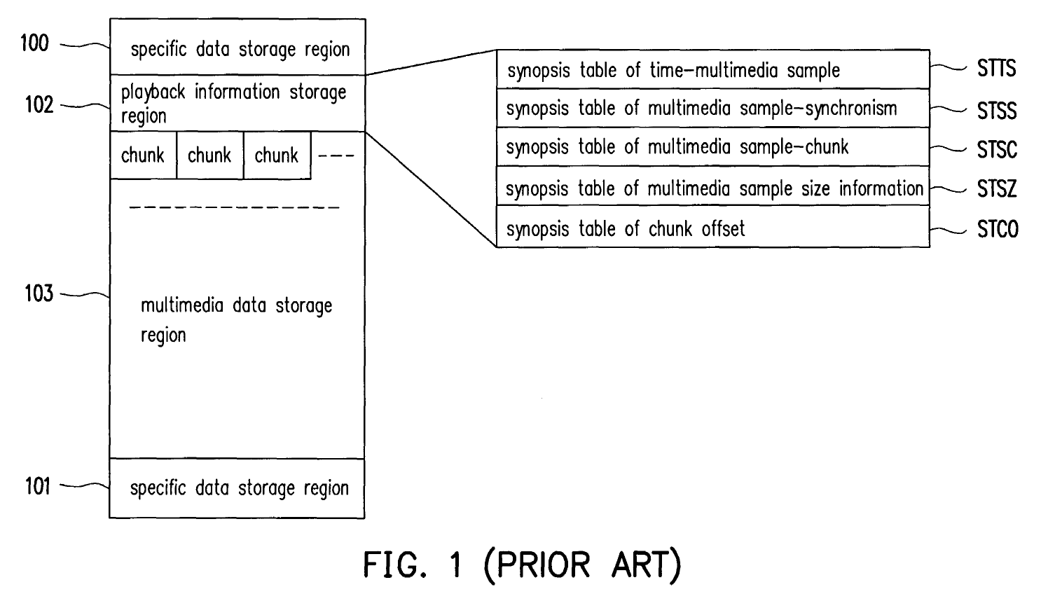

In the conventional art, when a multimedia file in an ISO/IEC 14496 file format (e.g., Nero Digital or Quick Time) is intended to be played by an optical storage media with limited memory (e.g., sounder/VCD/DVD player), since the multimedia file (shown in FIG. 1) includes a playback information storage region 102 and a multimedia data storage region 103, which are used for storing playback information and multimedia data respectively, the optical pickup head must be frequently switched back and forth for reading. When the media data is far away from the original playback information, unsmooth playback will occur. Furthermore, since the devices all have limited memories, it is impossible to store all the playback information (e.g., five tables mentioned in the conventional art) in the memory. Therefore, the present invention provides a method to solve the above mentioned problem, which is illustrated below through embodiments.

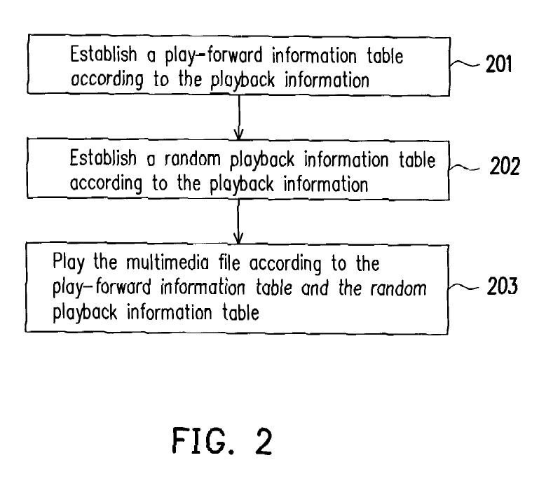

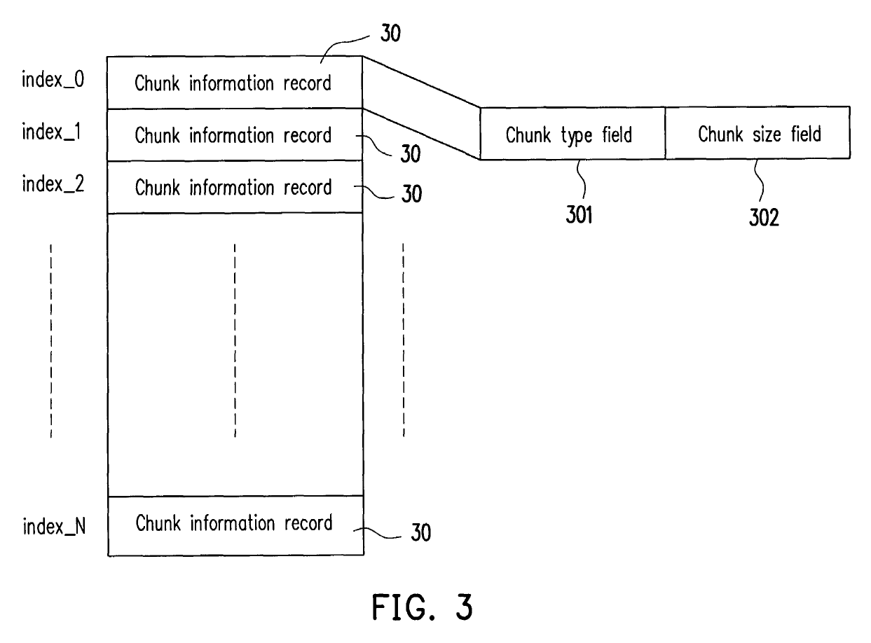

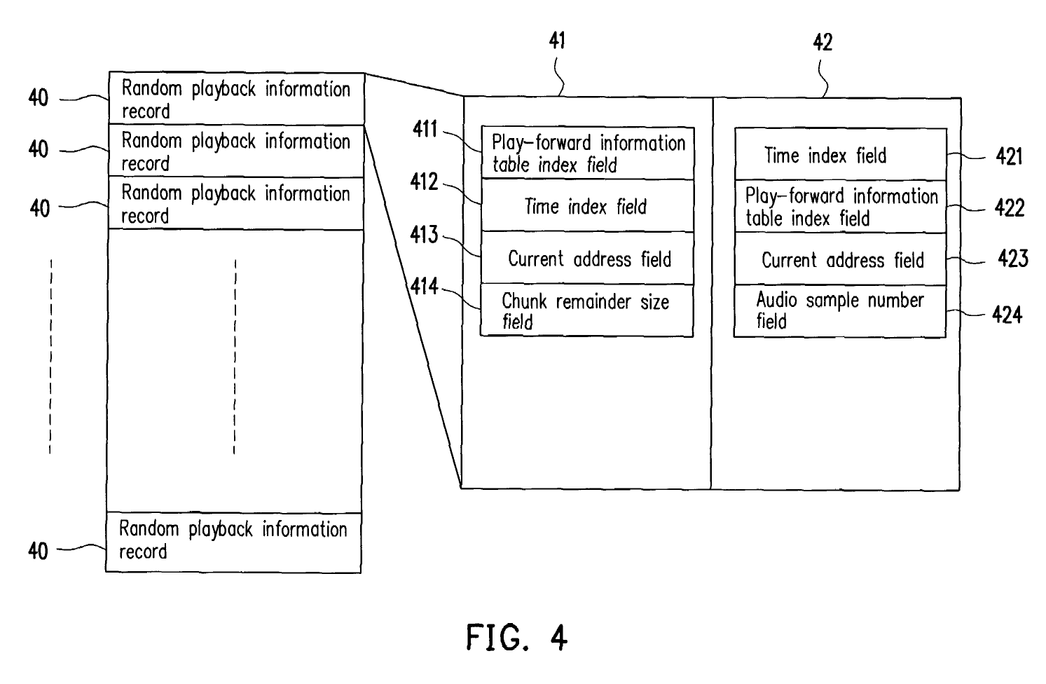

FIG. 2 shows a flow chart of a method of multimedia file playback for an optical storage medium according to an embodiment of the present invention. FIG. 3 shows a play-forward information table established before playing the multimedia file according to an embodiment of the present invention. FIG. 4 shows a random playback information table established before playing the multimedia file according to an embodiment of the present invention. Referring to FIG.2, FIG. 3, and FIG. 4, taking the file in an ISO/IEC 14496 file format of FIG. 1 as an example, a play-forward information table is established first according to the playback information (Step 201) shown in FIG.3, wherein the playback information includes the synopsis table of time-multimedia sample (STTS), synopsis table of multimedia sample-synchronism (STSS), synopsis table of multimedia sample-chunk (STSC), synopsis table of multimedia sample size information (STSZ), and synopsis table of chunk offset (STCO). The play-forward information table includes N chunk information records 30, and the indexes of the chunk information records are sequentially defined to be index_I, where N is a natural number, and I is a number from 0 to N. Each chunk information record includes a chunk type field 301 and a chunk size field 302.

The play-forward information table of the embodiment is mainly used to sort and extract the playback information distributed in various forms of multimedia samples, and establish a single play order; that is, to classify the adjacent identical samples in the media data into the same chunk data. The adjacent video samples are combined into one video chunk, the adjacent audio samples are combined into one audio chunk, the adjacent title samples are combined into one title chunk, and the data irrelevant to the playback are combined into one discard chunk. Then, the size information of each chunk is calculated. Before the playback, the user selects the audio data (e.g., English speech) and the title (e.g., Chinese title) to be played, such that other speeches, other titles, and other data irrelevant to the playback in the multimedia file are classified into a discard chunk when establishing the table, and these are recorded to the field of this play-forward information table. If the user has not yet selected the audio data or title to be played, the predetermined audio data and titles are selected and used for classification, and other data are classified into the discard chunk, and are recorded to the field of the play-forward information table.

In this embodiment, the chunk type field 301 is 3 bits, and the chunk size field 302 is 13 bits. Since there are only four types of chunk types in the embodiment of the present invention, when the length of a chunk data indicated by a specific chunk information record is excessively long that the chunk size filed in the specific chunk information record is unable to represent the length of the chunk data indicated by the chunk information record, another specific bit is used to record the length of the chunk data indicated by the specific chunk information record by using the chunk size fields of two block information records. The first field records the multiple of the excessively long chunk data to the chunk data with the maximum length that can be recorded, and the second field records the difference there-between. The actual size can be obtained by multiplying the recorded maximum size with the multiple in the first field and added by the difference in the second field, and the specific bit of the chunk type field in the chunk information record is changed into a specific value, for example, logic 1; thus, by reading the specific bit of the chunk type field 301, it can be known that the next chunk information record also records chunk data with the same type.

Next, a random playback information table is established according to the playback information, as shown in FIG. 4 (Step 202). The random playback information table includes a plurality of random playback information records 40, and each random playback information record includes two fields: a key frame information field 41 used for representing the related information of a synchronous frame (e.g., intra coded frame (I-frame)) in the media data of the multimedia file, and a relevant audio information field 42 used for representing the information of relevant audio corresponding to the synchronous frame.

The key frame information field 41 includes a play-forward information table index field 411, a time index field 412, a current address field 413, and a chunk remainder size field 414. The play-forward information table index field 411 is used to store the index (index_{—}0-index_N in FIG. 3) of the chunk information record corresponding to the chunk data where the synchronous frame (e.g., I-frame) is located. The time index field 412 is used to store the time elapsed from the beginning to the time for playing the synchronous frame when playing the media data in the multimedia file. The current address field 413 is used to store the current address of the synchronous frame in the multimedia file. The chunk remainder size field 414 is used to store the length from the synchronous frame to the end point of the chunk data where the synchronous frame is located.

The relevant audio information field 42 includes a time index field 421, a play-forward information table index field 422, a current address field 423, and an audio sample number field 424. The time index field 421 is used to store the time elapsed from the beginning to the time for playing the relevant audio data when playing the media data in the multimedia file. The play-forward information table index field 422 is used to store the index of the chunk information record corresponding to the synchronous frame in the playback time sequence. The current address field 423 is used to store the address of the audio data in the chunk data corresponding to the synchronous frame in the playback time sequence. The audio sample number field 424 is used to store an audio index, which directs to an audio sample stored in the chunk data corresponding to the synchronous frame in the playback time sequence.

When the multimedia file is to be sequentially played from the beginning, it needs to directly refer to the play-forward information table shown in FIG.3. According to the index_I of the chunk information record 30, the chunk information records are read sequentially according to the order of index_{—}0-index_N. The chunk data in the multimedia data is obtained according to the information recorded in the chunk type field 301 and the chunk size field 302 of the chunk information record 30. The chunk data is respectively sent to the corresponding processing units according to the chunk types recorded in the chunk type field 301, for example, the chunk data in video form is sent to the video processing module, the chunk data in audio form is sent to the audio processing module, the chunk data in title form is sent to the title processing module, and the chunk data in discard form is discarded.

When the multimedia file is to be played at random, for example, the user specifies the playback time (through controlling the DVD player with a remote controller), it requires to refer to both the play-forward information table in the embodiment of FIG. 3 and the random playback information table in the embodiment of FIG. 4. First, referring to the random playback information table, the playback sequence of the video and audio data corresponding to the specified time is determined, and the playback information of the start point is obtained according to the playback sequence. Referring to the play-forward information table index field of audio and video data, it is determined whether or not there is chunk data to be discarded in the audio and video data to be played, and the audio and video data are sequentially played with reference to the play-forward information table. When the audio data has a variable bit transmission rate, the size information of each audio sample is required to be recorded or dynamically accessed. The initial position and end position of each audio sample are obtained according to this information, and the time when it requires switching to play the next chunk is calculated.

For example, if it is determined that the video data is played first, the playback time is modified according to the time index field 412 in the key frame information field 41. The address of the synchronous frame in the multimedia file can be obtained through the address field 413 in the key frame information field 41. Next, the play-forward information table index field 411 is queried to find out the index (index_{—}0-index_N in FIG. 3) of the chunk information record corresponding to the chunk data where the synchronous frame is located, and then, the play-forward information table is queried according to the index of the chunk information record, so as to find out which chunk data the synchronous frame corresponding to the playback time specified by the user is located.

Then, with the chunk remainder size field 414, it can be known how much data is to be played before it needs to refer to the playback information in the next field of the play-forward information table. After the above initialization process has completed, the playback begins, and the data are played sequentially with reference to the play-forward information table.

If it is determined that the audio data is to be played first, the playback time is modified according to the time index field 412 in the key frame information field 41. The position of the audio data in the multimedia file is obtained according to the current position field 423 in the audio information field 42. The index of the chunk information record table corresponding to the chunk data where the audio data is located is obtained according to the play-forward information table index field 422. According to the time index field 421, the audio sample number field 424, and the STSZ table of the audio data, it can be known how much data is to be played before it needs to refer to the playback information in the next field of the play-forward information table. After the above initialization process has completed, the playback begins, and the data are played sequentially with reference to the play-forward information table.

As can be known from the above embodiments that the present invention sorts the conventional 5× M tables (M multimedia data forms) required for playing the multimedia file, and removes the redundant information in the playback information, so as to obtain the above-mentioned play-forward information table and random playback information table. With the sorting and removing processes, the originally existing playback data can be significantly simplified. The method of the present invention not only avoids the unsmooth playback caused by frequently switching the pickup head, but also enables a device of strict memory limitation to play multimedia files normally.

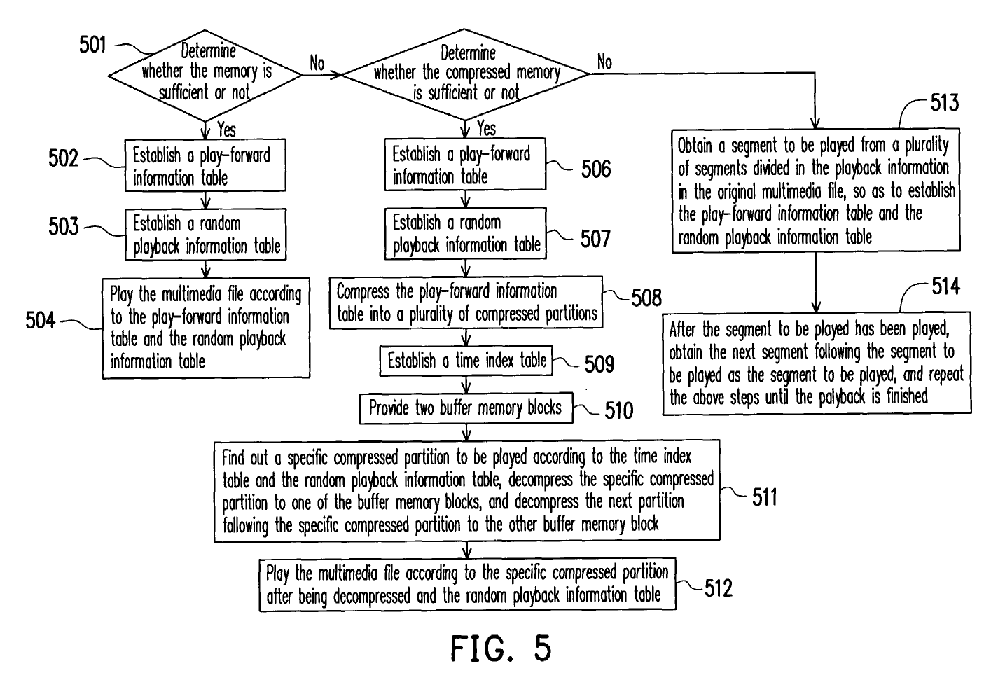

However, if the memory is still insufficient, the present invention further provides an embodiment of a method of multimedia file playback for an optical storage medium. FIG. 5 shows a flow chart of a method of multimedia file playback for an optical storage medium according to an embodiment of the present invention. Referring to FIG. 5, first, it is determined whether the memory space is sufficient or not (Step 501). If it is, the play-forward information table shown in FIG. 2 is started to be established (Step 502), the random playback information table is established (Step 503), and the multimedia file is played according to the play-forward information table and the random playback information table (Step 504). If it is not, it is determined whether or not the memory is sufficient after being compressed (Step 505). If the memory is determined to be sufficient after being compressed, the play-forward information table is established (Step 506), and the random playback information table is established (Step 507).

Next, the play-forward information table is compressed into a plurality of compressed partitions (Step 508). Then, a time index table for recording the starting playback time of each compressed partition is established (Step 509). Two buffer memory blocks are provided (Step 510). The specific compressed partition to be played is found out according to the time index table and the random playback information table and then decompressed to one of the above two buffer memory blocks, and the next partition following the specific compressed partition is decompressed to the other buffer memory block (Step 511). Finally, the multimedia file is played according to the compressed partitions after being decompressed and the random playback information table (Step 512). Although only the play-forward information table is compressed in the embodiment of the present invention, those skilled in the art should know that the random playback information table also can be compressed.

The above embodiment is summarized herein. As for the two buffer memory blocks used in the above embodiment, when the first buffer memory block is decompressed, the second buffer memory block is used to store the play-forward information table after being decompressed, so as to play the multimedia file. When the second buffer memory block has finished the playback process, the play-forward information table decompressed in the first buffer memory block is used to play the multimedia file, and then the second buffer memory block is used to decompress the next compressed partition to be played, and so forth. The operations are cycled as described above.

If the memory is determined to be insufficient after being compressed in Step 505, it indicates that the memory is still insufficient for playing the multimedia file in the compressed manner. At this time, a segment playing method is employed. First, when the memory is determined to be insufficient, a segment to be played is obtained from a plurality of segments divided in the playback information in the original multimedia file, so as to establish a play-forward information table and a random playback information table (Step 513). When the segment to be played has been played, the next segment following the segment to be played is obtained as a segment to be played, and the above steps are repeated until the playback process is finished (Step 514).

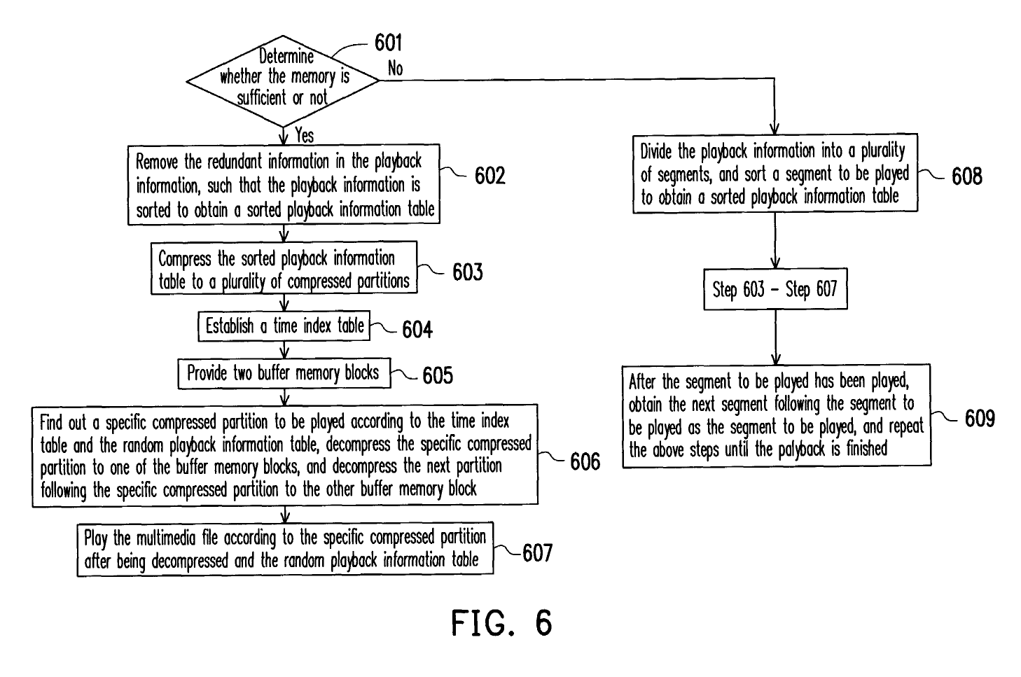

To further save the memory, the present invention further provides an embodiment of a method of multimedia file playback for an optical storage medium. FIG. 6 shows a flow chart of a method of multimedia file playback for an optical storage medium according to an embodiment of the present invention. Referring to FIG. 6, first, it is determined whether the memory is sufficient or not (Step 601). If it is, the redundant information in the playback information is removed, such that the playback information is sorted to obtain a sorted playback information table (Step 602), for example, the above-mentioned play-forward information table and the random playback information table. Next, the sorted playback information table is compressed into a plurality of compressed partitions (Step 603). Next, a time index table for recording the starting playback time of each compressed partition is established (Step 604). Two buffer memory blocks are provided (Step 605). A specific compressed partition to be played is found out according to the time index table, and then decompressed to one of the buffer memory blocks, and the next partition following the specific compressed partition is compressed to the other buffer memory block (Step 606). Finally, the media data is read according to the compressed partitions after being decompressed, so as to play the multimedia file (Step 607).

When the memory is determined to be insufficient, the playback information is divided into a plurality of segments, and a segment to be played is sorted to obtain a sorted playback information table (Step 608). Next, Steps 603-607 are performed. When the segment to be played has been played, the next segment is sorted to obtain a sorted playback information table, until the playback process is finished (Step 609).

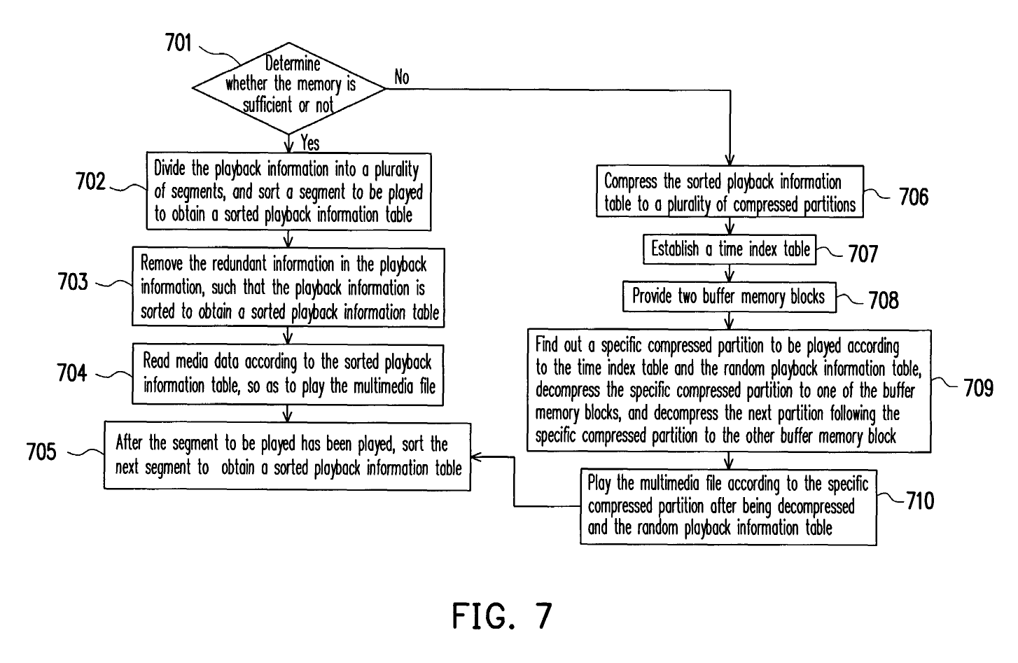

Another method is shown in FIG. 7, which indicates a flow chart of a method of multimedia file playback for an optical storage medium according to an embodiment of the present invention. Referring to FIG. 7, first, the memory is determined to be sufficient or not (Step 701). If it is, the playback information in the multimedia file is divided into a plurality of segments (Step 702). The redundant information in the playback information corresponding to the segment to be played is removed according to the segment to be played, such that the playback information is sorted to obtain a sorted playback information table (Step 703). Next, the media data is read according to the sorted playback information table, so as to play the multimedia file (Step 704). After the segment to be played has been played, the next segment is sorted to obtain the sorted playback information table, and the above actions are repeated (Step 705).

When the memory is determined to be insufficient, the sorted playback information table is compressed into a plurality of compressed partitions (Step 706). Next, a time index table for recording the starting playback time of each compressed partition is established (Step 707). Two buffer memory blocks are provided (Step 708). Then, a specific compressed partition to be played is found out according to the time index table, and then decompressed to one of the buffer memory blocks, and the next partition following the specific compressed partition is decompressed to the other buffer memory block (Step 709). Finally, the media data is read according to the compressed partitions after being decompressed, so as to play the multimedia file (Step 710).

In summary, because the present invention sorts the playback information in the multimedia data to obtain the sorted playback information table, 60%-80% of the memory space for storing the playback information table can be saved. With this method, the originally existing playback data is significantly simplified. The method not only avoids the unsmooth playback caused by frequently switching the pickup head, but also enables a device of strict memory limitation to play a multimedia file normally. Furthermore, according to the embodiments of the present invention, the dividing and compressing methods are used for the circumstance that the memory is limited, so as to further reduce the use of memory.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of multimedia file playback for an optical storage medium, suitable for playing a multimedia file stored in the optical storage medium, wherein the multimedia file includes a playback information and media data, comprising:
establishing a play-forward information table containing N chunk information records according to the playback information, defining required media types according to the media data in the file, sequentially defining indexes of the chunk information records, wherein N is a natural number, and each chunk information record includes:
a chunk type field, for storing a media form of a chunk data defined as adjacent and identical media data required when playing the multimedia file, wherein the media type includes a video type, an audio type, and a discard type;
a chunk size field, for storing the length of the chunk data indicated by the chunk type field; and
playing the multimedia file according to the play-forward information table.

2. The method of multimedia file playback for an optical storage medium as claimed in claim 1, further comprising:
when a random playback function is supported, establishing a random playback information table containing a plurality of random playback information records according to the playback information, wherein each playback information record includes:
a key frame information field, for representing relevant information of a synchronous frame in the media data of the multimedia file, comprising a current address field for storing a current address of the synchronous frame in the multimedia file, a chunk remainder size field for storing a distance from the synchronous frame to the end point of the chunk data where the synchronous frame is located, a play-forward information table index field for storing the index of the chunk information record corresponding to the chunk data where the synchronous frame is located, and a time index field for storing the time elapsed from the beginning to the time for playing the synchronous frame when playing the media data of the multimedia file; and
a relevant audio information field, for representing information of a relevant audio corresponding to the synchronous frame, comprising an audio sample number field for storing an audio index directing to an audio sample stored in the chunk data corresponding to the synchronous frame in the playback time sequence; and
playing the multimedia file according to the play-forward information table and the random playback information table.

3. The method of multimedia file playback for an optical storage medium as claimed in claim 1, further comprising:
when the memory is determined to be insufficient, alternatively compressing the play-forward information table and the random playback information table into a plurality of compressed partitions; and
establishing a time index table, for recording starting playback time of each compressed partition.

4. The method of multimedia file playback for an optical storage medium as claimed in claim 3, wherein the step of playing the multimedia file according to the play-forward information table and the random playback information table comprises:
providing two buffer memory blocks;
finding out a specific compressed partition to be played according to the time index table and the random playback information table, decompressing the specific compressed partition to the one of buffer memory blocks, and decompressing the next partition following the specific compressed partition to the other one of buffer memory blocks; and
playing the multimedia file according to the specific compressed partitions after being decompressed and the random playback information table.

5. The method of multimedia file playback for an optical storage medium as claimed in claim 1, further comprising:
when the memory is determined to be insufficient, obtaining a segment to be played according to a plurality of segments divided in the playback information, so as to establish the play-forward information table and the random playback information table; and
after the segment to be played has been played, obtaining the next segment following the segment to be played as the segment to be played, and repeating the above steps.

6. The method of multimedia file playback for an optical storage medium as claimed in claim 2, wherein the relevant audio information field further comprises:
a play-forward information table index field, for storing the index of the chunk information record corresponding to the synchronous frame in the playback time sequence.

7. The method of multimedia file playback for an optical storage medium as claimed in claim 2, wherein the relevant audio information field further comprises:
a current address field, for storing the address of the audio data in the chunk data corresponding to the synchronous frame in the playback time sequence.

8. The method of multimedia file playback for an optical storage medium as claimed in claim 2, wherein the relevant audio information field further comprises:
a time index field, for storing a time difference between the audio data and the starting position of the corresponding chunk data.

9. The method of multimedia file playback for an optical storage medium as claimed in claim 1, wherein the chunk size field is used to record length information of the chunk data.

10. The method of multimedia file playback for an optical storage medium as claimed in claim 1, further comprising:
using a plurality of chunk size fields of chunk information records to record a length of the chunk data indicated by a specific chunk information record, when the length of the chunk data indicated by the specific chunk information record is so excessively long that the chunk size field in the specific chunk information record is unable to represent the length of the chunk data indicated by the specific chunk information record.

11. The method of multimedia file playback for an optical storage medium as claimed in claim 1, wherein the format of the multimedia file is an ISO/IEC 14496 format.

12. A method of multimedia file playback for an optical storage medium, suitable for playing a multimedia file in an ISO/IEC 14496 format stored in the optical storage medium, wherein the multimedia file includes a playback information and media data, the method comprising:
removing redundant information in the playback information, such that the playback information is sorted to obtain a sorted playback information table and a random playback information table;
compressing the sorted playback information table into a plurality of compressed partitions;
establishing a time index table used for recording each starting playback time of the compressed partitions; and
decompressing the compressed partitions sequentially according to the time index table to read the media data, so as to play the multimedia file in the ISO/IEC 14496 format.

13. The method of multimedia file playback for an optical storage medium as claimed in claim 12, wherein the step of decompressing the compressed partitions sequentially according to the time index table to read the media data so as to play the multimedia file in the ISO/IEC 14496 format comprises:
providing two buffer memory blocks;
finding out a specific compressed partition to be played according to the time index table, decompressing the specific compressed partition to the one of buffer memory blocks, and decompressing the next partition following the specific compressed partition to the other one of buffer memory block; and
reading the media data according to the specific compressed partitions after being decompressed, so as to play the multimedia file in the ISO/IEC 14496 format.

14. The method of multimedia file playback for an optical storage medium as claimed in claim 12, wherein the step of sorting the playback information into a sorted playback information table and a random playback information table comprises:
when the memory is determined to be insufficient, obtaining a segment to be played according to a plurality of segments divided in the playback information, and sorting the segment to be played to obtain the sorted playback information table.

15. The method of multimedia file playback for an optical storage medium as claimed in claim 14, further comprising:
after the segment to be played has been played, sorting the next segment to obtain the sorted playback information table and the random playback information table.

16. A method of multimedia file playback for an optical storage medium, suitable for playing a multimedia file in an ISO/IEC 14496 format stored in the optical storage medium, wherein the multimedia file includes a playback information and media data, the method comprising:
dividing the playback information into a plurality of segments;
according to a segment to be played, removing redundant information in the playback information corresponding to the segment to be played, such that the playback information is sorted to obtain a sorted playback information table;
reading the media data according to the sorted playback information, so as to play the multimedia file in the ISO/IEC 14496 format; and
after the segment to be played has been played, sorting the next segment to obtain a sorted playback information table.

17. The method of multimedia file playback for an optical storage medium as claimed in claim 16, further comprising:
when the memory is determined to be insufficient, compressing the sorted playback information table into a plurality of compressed partitions; and
establishing a time index table used for recording each starting playback time of the compressed partitions.

18. The method of multimedia file playback for an optical storage medium as claimed in claim 17, wherein the step of reading the media data according to the sorted playback information table so as to play the multimedia file in the ISO/IEC 14496 format comprises:
providing two buffer memory blocks;
finding out a specific compressed partition to be played according to the time index table, decompressing the specific compressed partition to the one of buffer memory blocks, and decompressing the next partition following the specific compressed partition to the other one of buffer memory block; and
reading the media data according to the specific compressed partitions after being decompressed, so as to play the multimedia file in the ISO/IEC 14496 format.
